(19) United States
(12) Patent Application Publication
(10) Pub. No.: US 2020/0327470 A1
(43) Pub. Date: Oct. 15, 2020

(54) Cognitively-Derived Knowledge Base of Supply Chain Risk Management

(71) Applicant: International Business Machines Corporation, Armonk, NY (US)

(72) Inventors: Craig M. Trim, Ventura, CA (US); Michael Bender, Rye Brook, NY (US); Aaron K. Baughman, Cary, NC (US); Martin G. Keen, Cary, NC (US)

(21) Appl. No.: 16/383,779

(22) Filed: Apr. 15, 2019

(51) Int. Cl. G06Q 10/06; G06N 5/04

(52) U.S. Cl. CPC G06Q 10/06315; G06N 5/045; G06Q 10/0635

(57) ABSTRACT

Supply chain risk management is provided. A supply chain risk management knowledge base that includes dynamic relations between supply chain entities that contribute to supply chain risk is automatically generated. A probabilistic decision-making path is generated for a workflow of a supply chain that reduces the supply chain risk based on information extracted from the supply chain risk management knowledge base.

### BACKGROUND

### 1. Field

The disclosure relates generally to supply chain risk management and more specifically to generating and maintaining a supply chain risk management knowledge base of dynamic relations between linked supply chain entities that contribute to risk in a supply chain and generating a probabilistic decision-making path through a weighted decision matrix using cognitive analysis to decrease the risk to the supply chain.

### 2. Description of the Related Art

A supply chain is a system of entities, such as enterprises, organizations, people, activities, information, and resources, involved in moving a product or parts from supplier to consumer. Supply chain activities involve the transformation of natural resources, raw materials, and components into a finished product that is delivered to the end customer. In sophisticated supply chain systems, used products may re-enter the supply chain at any point adding to supply chain complexity.

Supply chain risk management is the implementation of strategies to manage both frequently occurring and exceptional risks along a supply chain based on continuous risk assessment with the objective of reducing vulnerability and ensuring continuity. In other words, supply chain risk management applies risk management tools to deal with risks and uncertainties caused by, or affecting, logistics-related activities or resources in the supply chain. Supply chain risk management attempts to reduce supply-chain vulnerability via a coordinated approach, involving linked supply-chain entities, which identifies and analyzes the risk of failure points within the supply chain.

Risks to the supply chain range from unpredictable natural threats to counterfeit products, and involve quality, security, resiliency, and product integrity. Mitigation plans to manage these risks can involve logistics, cybersecurity, finance, and risk management disciplines. One goal of supply chain risk management is to ensure supply chain continuity in the event of a scenario which otherwise disrupt normal business and, therefore, profitability.

### SUMMARY

According to one illustrative embodiment, a computer-implemented method for supply chain risk management is provided. A supply chain risk management knowledge base that includes dynamic relations between supply chain entities that contribute to supply chain risk is automatically generated. A probabilistic decision-making path is generated for a workflow of a supply chain that reduces the supply chain risk based on information extracted from the supply chain risk management knowledge base. According to other illustrative embodiments, a computer system and computer program product for supply chain risk management are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a cognitive risk management decision-making process in accordance with an illustrative embodiment;

FIG. 4 is a diagram illustrating an example of a weighted decision matrix in accordance with an illustrative embodiment;

FIG. 5 is a flowchart illustrating a process for generating a probabilistic decision-making path in accordance with an illustrative embodiment; and

FIG. 6 is a flowchart illustrating a process for supply chain risk management in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

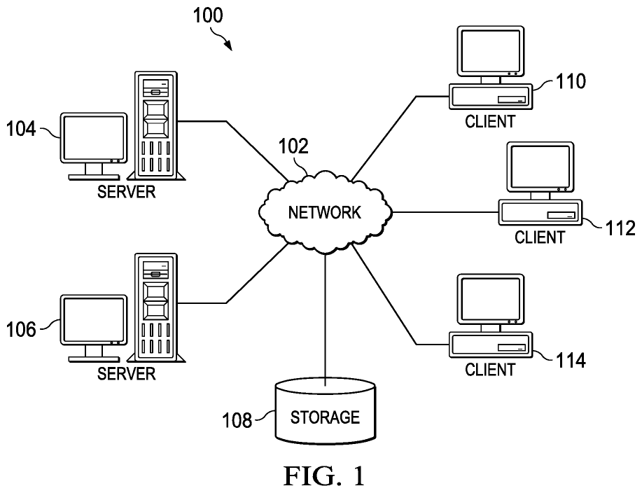

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 provide supply chain risk management services to registered client device users. Also, it should be noted that server 104 and server 106 may represent clusters of servers in a data center. Alternatively, server 104 and server 106 may represent computing nodes in a cloud environment that provides supply chain risk management services.

Client 110, client 112, and client 114 also connect to network 102. Clients 110, 112, and 114 are clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, smart phones, smart televisions, and the like. Users of clients 110, 112, and 114 may utilize clients 110, 112, and 114 to access and utilize the supply change risk management services provided by server 104 and server 106.

Storage 108 is a network storage device capable of storing any type of data in a structured format or an unstructured format. In addition, storage 108 may represent a plurality of network storage devices. Further, storage 108 may store identifiers and network addresses for a plurality of different supply chain servers, identifiers and network addresses for a plurality of different supply chain client devices, identifiers for a plurality of registered users, supply chain data, global event data that corresponds to the supply chain data, Likert disruption scale data corresponding to the global event data, and the like. Furthermore, storage 108 may store other types of data, such as authentication or credential data that may include user names, passwords, and biometric data associated with registered client device users, system administrators, and security analysts, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), a telecommunications network, or any combination thereof. FIG. 1 is intended as an example only, and not as an architectural limitation for the different illustrative embodiments.

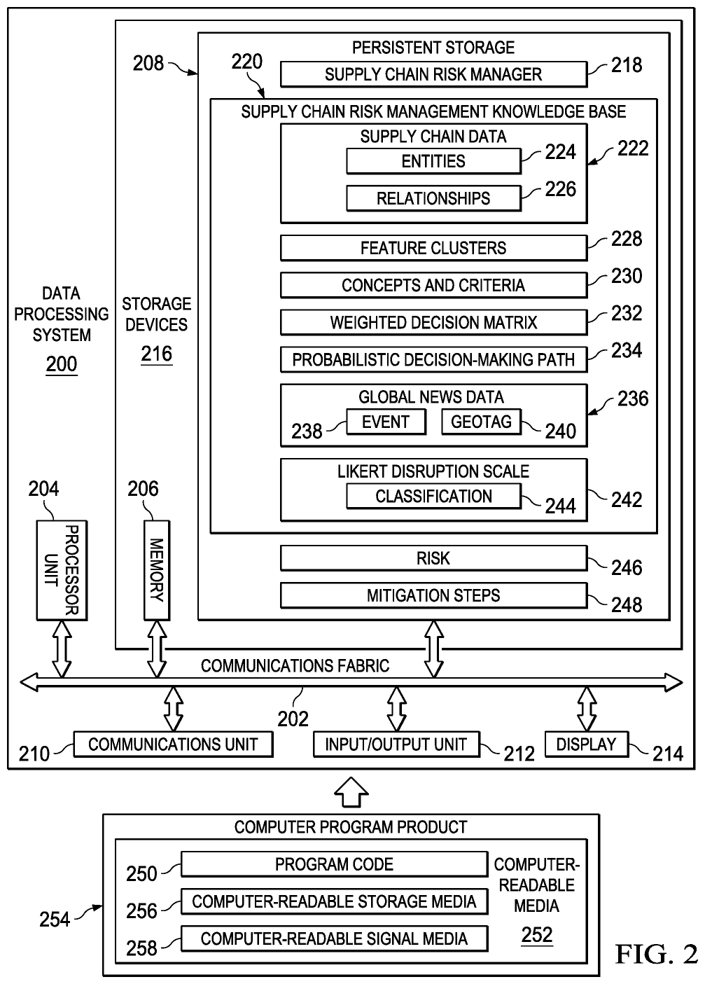

With reference now to FIG. 2, a diagram of a data processing system is depicted in accordance with an illustrative embodiment. Data processing system 200 is an example of a computer, such as server 104 in FIG. 1, in which computer readable program code or instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random-access memory (RAM), or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores supply chain risk manager 218. However, it should be noted that even though supply chain risk manager 218 is illustrated as residing in persistent storage 208, in an alternative illustrative embodiment supply chain risk manager 218 may be a separate component of data processing system 200. For example, supply chain risk manager 218 may be a hardware component coupled to communication fabric 202 or a combination of hardware and software components. In another alternative illustrative embodiment, a first set of components of supply chain risk manager 218 may be located in data processing system 200 and a second set of components of supply chain risk manager 218 may be located in a second data processing system, such as, for example, server 106 in FIG. 1. In yet another alternative illustrative embodiment, supply chain risk manager 218 may be located in registered client devices, such as clients 110-114 in FIG. 1, in addition to, or instead of, data processing system 200.

Supply chain risk manager 218 controls the process of generating and maintaining supply chain risk management knowledge base 220. Supply chain risk management knowledge base 220 is a database of dynamic relations between linked supply chain entities that contribute to supply chain risk. Supply chain risk management knowledge base 220 stores supply chain data 222. Supply chain data 222 represent information from a plurality of different supply chain data sources, such as, for example, suppliers, consumers, manufacturers, third-parties, public and private databases, and the like, corresponding to one or more identified supply chains.

In this example, supply chain data 222 include entities 224 and relationships 226. However, it should be noted that supply chain data 222 may include any type of information corresponding to the one or more identified supply chains. Entities 224 represent all known entities, such as, for example, raw material sources, vendors, suppliers, manufacturers, distributors, consumers, and the like, in a particular supply chain. Relationships 226 represent dynamic relations between entities 224 that are linked in that particular supply chain and contribute to supply chain risk.

Supply chain risk manager 218 automatically extracts features corresponding to that particular supply chain from supply chain data 222. Further, supply chain risk manager 218 clusters the extracted features using a clustering function, such as, for example, a K-means clustering algorithm or an artificial neural network, to form feature clusters 228. Feature clusters 228 represent a plurality of different clusters of features and each feature cluster is a separate dataset comprised of a set of elements.

Supply chain risk manager 218 generates concepts and criteria 230 based on feature clusters 228. Concepts and criteria 230 include a set of concepts, such as, for example, a set of product transportation trips, corresponding to the supply chain, each concept in the set having a set of corresponding criteria, such as, for example, travel cost, pickup and destination locations, travel time, travel safety, and the like.

Supply chain risk manager 218 generates weighted decision matrix 232 based on concepts and criteria 230. For example, supply chain risk manager 218 may utilize concepts and criteria 230 to form the columns (e.g., concepts) and the rows (e.g., criteria) of weighted decision matrix 232. Supply chain risk manager 218 generates a weight and a rating for each criterion of each concept within weighted decision matrix 232 using machine learning. Supply chain risk manager 218 also generates a score for each criterion based on the criterion's corresponding weight and rating. In addition, supply chain risk manager 218 further generates a total score for each concept by adding individual scores of each criterion for each respective concept. Furthermore, supply chain risk manager 218 ranks each concept based on each concept's total score.

Supply chain risk manager 218 generates probabilistic decision-making path 234 using the information in weighted decision matrix 232. Probabilistic decision-making path 234 represents the most efficient way through weighted decision matrix 232. Supply chain risk manager 218 utilizes probabilistic decision-making path 234 to understand the relationships between the concepts and criteria to generate a workflow for the supply chain.

Moreover, supply chain risk manager 218 utilizes global news data 236 to identify event 238. Global news data 236 represent information and intelligence that supply chain risk manager 218 retrieves and/or receives from a plurality of new sources from around the world. Event 238 represents an occurrence or incident, such as, for example, bankruptcy filing, workforce strike, and the like, that may affect the supply chain either positively or negatively. In addition, event 238 may represent a plurality of different events. Supply chain risk manager 218 also applies geotag 240 to event 238. Geotag 240 represents a geographical location label or identifier that corresponds to the location of event 238. Geotag 240 may link to one or more entities in the supply chain.

Further, supply chain risk manager 218 classifies event 238 according to Likert disruption scale 242. Likert disruption scale 242 measures or gauges an amount of disruption or disturbance in the supply chain caused by an event, such as event 238. Likert disruption scale 242 may be in gradation from one to five, with one being good, three being neutral, and five being bad. Classification 244 represents the disruption rating or value (i.e., 1, 2, 3, 4, or 5) that supply chain risk manager 218 applies to event 238 based on machine learning.

Risk 246 represents an estimated level or degree of risk that a potential supply chain outcome differs from an expected outcome. Supply chain risk manager 218 estimates risk 246 corresponding to the supply chain based on probabilistic decision-making path 234 and classification 244 of event 238. In response to supply chain risk manager 218 determining that risk 246 is greater than or equal to a defined risk threshold level, supply chain risk manager 218 performs mitigation steps 248. Mitigation steps 248 represent a set of one or more mitigation action steps to reduce or eliminate the level of risk associated with risk 246. Mitigation steps 248 may include, for example, supply chain risk manager 218 sending an alert to a system administrator or security analyst for review and possible corrective action. Mitigation steps 248 may also include supply chain risk manager 218 automatically performing one or more steps, such as, for example, automatically ordering parts in response to determining that a part storage exists in inventory, automatically ordering parts from another supplier in response to receiving an indication from the current supplier that the supplier will not be able to meet demand, automatically stopping production of parts in response to cancelled orders from part consumers due to defects, and the like.

As a result, data processing system 200 operates as a special purpose computer system in which supply chain risk manager 218 in data processing system 200 enables management of risk in a supply chain by identifying relationships and events that affect the supply chain. In particular, supply chain risk manager 218 transforms data processing system 200 into a special purpose computer system as compared to currently available general computer systems that do not have supply chain risk manager 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 250 is located in a functional form on computer readable media 252 that is selectively removable and may be loaded onto or transferred to data processing system 200 for running by processor unit 204. Program code 250 and computer readable media 252 form computer program product 254. In one example, computer readable media 252 may be computer readable storage media 256 or computer readable signal media 258. Computer readable storage media 256 may include, for example, an optical or magnetic disc that is inserted or placed into a drive or other device that is part of persistent storage 208 for transfer onto a storage device, such as a hard drive, that is part of persistent storage 208. Computer readable storage media 256 also may take the form of a persistent storage, such as a hard drive, a thumb drive, or a flash memory that is connected to data processing system 200. In some instances, computer readable storage media 256 may not be removable from data processing system 200.

Alternatively, program code 250 may be transferred to data processing system 200 using computer readable signal media 258. Computer readable signal media 258 may be, for example, a propagated data signal containing program code 250. For example, computer readable signal media 258 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 250 may be downloaded over a network to persistent storage 208 from another device or data processing system through computer readable signal media 258 for use within data processing system 200. For instance, program code stored in a computer readable storage media in a data processing system may be downloaded over a network from the data processing system to data processing system 200. The data processing system providing program code 250 may be a server computer, a client computer, or some other device capable of storing and transmitting program code 250.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 256 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Supply chain risk management addresses developing strategies to continually manage both frequently occurring and exceptional risks along a supply chain. Supply chain systems have internal triggering and interactive risk mechanisms regarding a product or parts. Typically, supply chain risk management involves four processes: identification, assessment, controlling, and monitoring of supply chain risks. However, due to the complexity of many supply chains, these four processes may not be sufficient to ensure that all eventualities are prepared for.

Illustrative embodiments focus on three types of risk: relationship risk, bilateral risk, and unilateral risk, which require risk management. Relationship risk is an inherent risk between suppliers and consumers across a supply chain. For example, in today's global economy a surplus of suppliers exists. The presence of so many suppliers makes it challenging for a consumer to justify the maintenance of a relationship with only one supplier over an extended period of time. Bilateral risk is a risk that impacts both supplier and consumer. For example, logistics cycles of increasing length affect product availability and increase the risk of product inventory obsolescence. Unilateral risk is a risk that impacts only a supplier or a consumer. For example, product catalogs continue to expand the global market and this expansion makes service support more difficult as an increasing amount of variations in parts and products exists. This leads to higher complexity and higher cost.

Illustrative embodiments cognitively and automatically generate and maintain a supply chain risk management knowledge base. Illustrative embodiments populate this knowledge base with information regarding dynamic relations between linked supply chain entities that contribute to supply chain risk. In addition, illustrative embodiments generate a probabilistic decision-making path through a weighted decision matrix to decrease the supply chain risk using cognitive analysis.

Illustrative embodiments cognitively analyze internal triggering and interactive risk mechanisms in a supply chain to generate and maintain the supply chain risk management knowledge base. Further, illustrative embodiments utilize a Likert disruption scale (e.g., scale from one to five, with one being good or the best, three being neutral, and five being bad or the worst) to classify global events that may affect the supply chain. Furthermore, illustrative embodiments may apply geotagging to the global events as a supply chain entity link and risk assessment indicator to identify disruption. Moreover, illustrative embodiments automatically extract features corresponding to the supply chain from information in the supply chain risk management knowledge base and generate clusters of features using a clustering function, such as a K-means clustering algorithm. Illustrative embodiments generate concepts and criteria corresponding to the supply chain based on the feature clusters. In addition, illustrative embodiments generate a weighted decision matrix using the concepts and criteria of the supply chain as columns and rows, respectively, in the matrix. Illustrative embodiments then utilize the weighted decision matrix to generate a probabilistic decision-making path through the weighted decision matrix to reduce risk for a workflow of that particular supply chain. Illustrative embodiments generate the workflow of the supply chain using self-organization based on the feature clusters.

Illustrative embodiments utilize the supply chain risk management knowledge base to manage quantitative uncertainty, cost uncertainty, and quality uncertainty in the supply chain. Quantitative uncertainty is an uncertainty regarding a quantity or amount of a product or parts, which will have a significant impact on supply chain operations. Supply chain entities, such as manufacturers, constantly need to predict demand. A false prediction may lead to shortage of parts and components and, thus, loss of product sales and clientele. A false prediction may also lead to an overage of parts and products, which in turn will increase cost by holding parts and products in inventory. Further, these parts and products may become obsolete while being held in inventory.

Cost uncertainty is an uncertainty regarding cost of products and parts. Cost uncertainty includes uncertainty in procurement cost and production cost. However, it should be noted that multiple ways of assessing cost exist and that multiple influencers may be associated with each cost point. Procurement cost is a cost corresponding to procuring or obtaining products and parts. Procurement cost tends to fluctuate externally to each vendor and supplier. For example, fluctuations may be due to global events, such as wars, natural disasters, epidemics, and the like, or wide-spread shortages caused either artificially or naturally due to increased complexity of obtaining a part. Production cost is a cost corresponding to producing or manufacturing parts and products. For example, utilities involved in production may have too much slack time, or there may be too many or too few shift employees, or longer lead times are needed.

Quality uncertainty is an uncertainty regarding a quality of a product or parts. For example, if the quality of a part or component suffers, then this decreases product production output and affects the consumer experience. As an example scenario, an automobile manufacturer may struggle to meet production targets due to part imperfections and may cause safety recalls, which affects consumer experience.

Illustrative embodiments first build the supply chain risk management knowledge base, which links all the supply chain entities, such as vendors, suppliers, distributors, consumers, and the like, within a supply chain. It should be noted that a large percentage of companies don't know their supply chain beyond first tier suppliers because these companies are not able to acquire that type of information due to time and cost constraints. Even though illustrative embodiments may not be able to obtain all supply chain information, illustrative embodiments do provide a basis for elucidating or revealing unknown data points regarding a supply chain. For example, if a supplier exists in the supply chain risk management knowledge base, but the supplier has no further connectivity to other suppliers and no further, or infrequently updated, connections to global events, then illustrative embodiments consider that supplier data point at-risk and insufficient for further analysis.

Illustrative embodiments also extract global events from a plurality of news sources from around the world and integrate, geotag, and classify each of the global events on a Likert disruption scale of one to five, with three being neutral. For example, if a news article regarding a particular country indicates a lowering of interest rates or a rise in gross domestic product, then illustrative embodiments may classify this global event as a one or a two because this type of global event would be considered “generally beneficial” to a supply chain. Conversely, a news article that indicates use of economic sanctions, outbreak of war or civil unrest, or natural disaster would be considered “generally detrimental” to a supply chain and illustrative embodiments would classify this type of global event as a four or five. The precise classification and leveraging of this data are a matter of machine learning by illustrative embodiments. For example, a supply chain recommendation that incorporates little risk, but is in reality higher risk due to global events, will be adjusted over time.

When performing analysis of complex data, one issue that arises is the number of variables involved. For example, there is a large amount of information connected to a supply chain, and this is a chief cause of complexity in performing supply chain risk management. Given that there are eight primary features of a supply chain, which include planning, information, source, inventory, production, location, transportation, and return of goods, these features involve a large number of variables. Feature extraction is a general term for methods of constructing combinations of variables to get around the issue of a large number of variables, while still describing the data with sufficient accuracy.

Within the source data of the supply chain risk management knowledge base from which illustrative embodiments perform feature extraction, complex supply chain relationships exist. These complex relationships determine probabilistic decision-making paths through a weighted decision matrix for next-best-action recommendations. In order to determine how these complex supply chain relationships are formed, the first step in building the supply chain risk management knowledge base is to cluster the data. The output of this clustering and feature extraction is an extraction of concepts and criteria for the purpose of generating the weighted decision matrix.

Illustrative embodiments import supply chain data from a plurality of different supply chain data sources, such as, for example, from vendors, suppliers, manufacturers, third-party sources, supply chain databases, and the like. Illustrative embodiments identify the most important feature variables in the supply chain dataset using, for example, a decision tree. Illustrative embodiments then remove or discard unnecessary variables from the supply chain dataset. Further, illustrative embodiments solve for missing supply chain data via functions that impute by mean and mode, respectively.

Illustrative embodiments execute a clustering function, such as, for example, a K-means clustering algorithm, to cluster the feature variables to form feature clusters. Each feature cluster is a separate, standardized dataset. For a relationship “X”, illustrative embodiments compare all “in” variables of an influencing cluster with each other for their relative importance to each variable “i” of an influenced cluster. A variable is a single record. A feature is made up of a set of variables. Illustrative embodiments compare all “in” variables of the influencing feature cluster in order to obtain the weights of these “in” variables with respect to each variable “i” of the influenced feature cluster. The weights of these “in” variables represent their relative importance of the influence on each variable “i”. For example:

X∈{A, . . . ,H,J}

Xₘₓₘⁱ

As a ranking method for feature clustering, illustrative embodiments run the clustering function continuously with the omission of specific feature variables at each interval. Initially, the variable omission will be a function of both intuition and brute force combinatorics. At the end of the feature clustering process, illustrative embodiments generate a decision-making weight matrix (i.e., a weighted decision matrix) using concepts and criteria extracted from the feature clusters. Illustrative embodiments position all column weight vectors {wi} in sequence for application of cognitive analysis.

Illustrative embodiments also take into account the relationships between generated feature clusters. In order for the weighted decision matrix to be effective, illustrative embodiments ensure that the criteria are independent of one another, or as nearly so as possible. In addition, illustrative embodiments rate the concepts before calculating the weights of the corresponding criteria in the weighted decision matrix.

Illustrative embodiments take a two-pass approach to find the clustering approach with the highest score. The first pass involves finding the variable combination with the highest Pseudo F Statistic. A Pseudo F Statistic is a value that describes the ratio of between-cluster variance to within-cluster variance. The idea is to find a variable combination that maximizes the Pseudo F Statistic value once illustrative embodiments selected the minimum number of variables. After illustrative embodiments find the variable combination that maximizes the Pseudo F Statistic value, illustrative embodiments then find the most appropriate number of clusters. The second pass iterates through the number of possible clusters while running the clustering algorithm and tracking the Approximate Expected Over-all R-Squared value. The Approximate Expected Over-all R-Squared value is the “percent of variance explained” by the model. The idea is to maximize the Approximate Expected Over-all R-Squared value by the omission of as many feature variables as possible. The highest Approximate Expected Over-all R-Squared value represents the best possible number of clusters.

Thus, illustrative embodiments provide one or more technical solutions that overcome a technical problem with identifying risks in a supply chain consisting of a large number of entities with complex relationships. As a result, these one or more technical solutions provide a technical effect and practical application in the field of supply chain risk management by providing supply chain insights into potential disruptions and problems in the supply chain before the disruptions or problems impact business and taking the appropriate mitigation action steps.

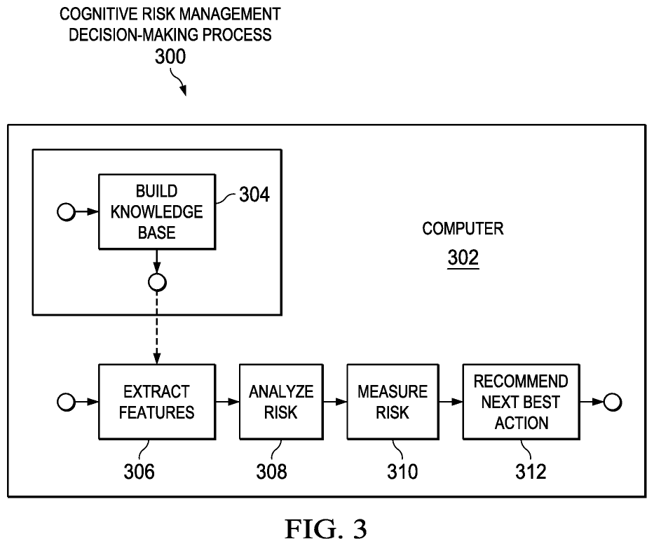

With reference now to FIG. 3, a diagram illustrating an example of a cognitive risk management decision-making process is depicted in accordance with an illustrative embodiment. Cognitive risk management decision-making process 300 is implemented in computer 302. Computer 302 may be, for example, server 104 in FIG. 1 or data processing system 200 in FIG. 2.

In this example, cognitive risk management decision-making process 300 includes steps 304, 306, 308, 310, and 312. However, it should be noted that alternative illustrative embodiments may include more or fewer steps than illustrated. For example, alternative illustrative embodiments may combine two or more steps into one step, split one step into two or more steps, add one or more steps not shown, remove one or more steps shown, and the like.

At 304, computer 302 builds a supply chain risk management knowledge base, such as supply chain risk management knowledge base 220 in FIG. 2. It should be noted that computer 302 maintains and continuously updates the supply chain risk management knowledge base as computer 302 obtains new supply chain data and global event data via a network, such as network 102 in FIG. 1. At 306, computer 302 extracts features corresponding to a supply chain from information contained in the supply chain risk management knowledge base.

At 308, computer 302, using machine learning, analyzes risk to the supply chain based on the extracted features. At 310, computer 302 measures the level of risk to the supply chain based on the analysis. At 312, computer 302 recommends a next-best-action based on the measured level of risk to the supply chain being greater than or equal to a defined risk threshold level. In addition, computer 302 may automatically perform one or more mitigation action steps, such as mitigation steps 248 in FIG. 2.

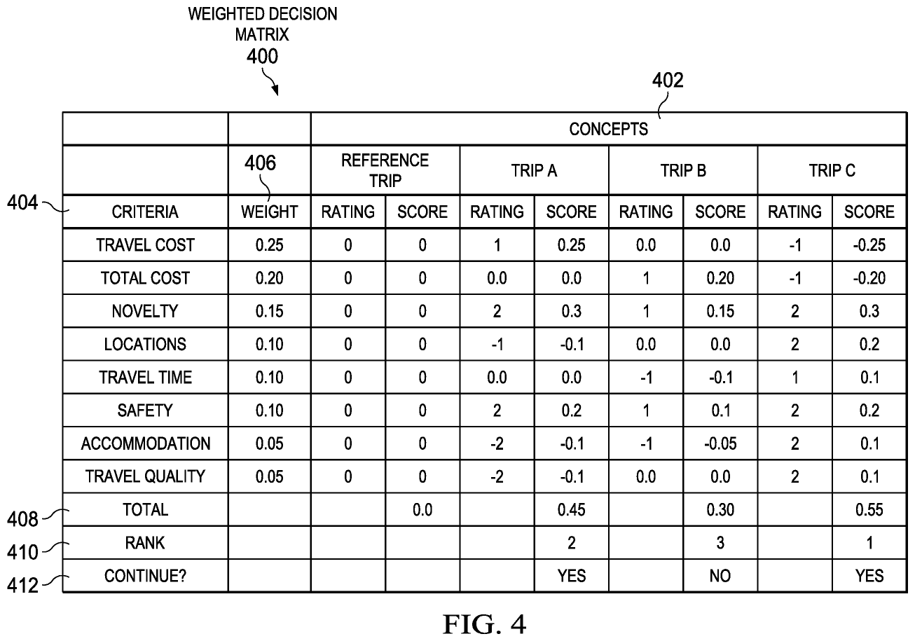

With reference now to FIG. 4, a diagram illustrating an example of a weighted decision matrix is depicted in accordance with an illustrative embodiment. Weighted decision matrix 400 is a weight table for making decisions regarding risk to a supply chain. Weighted decision matrix 400 may be, for example, weighted decision matrix 232 in FIG. 2.

In this example, weighted decision matrix 400 includes concepts 402, criteria 404, weights 406, total 408, rank 410, and decision 412. Concepts 402 and criteria 404 correspond to a particular supply chain. A supply chain risk manager, such as supply chain risk manager 218 in FIG. 2, generates concepts 402 and criteria 404 based on feature clusters, such as feature clusters 228 in FIG. 2, which were generated from features extracted from information corresponding to the supply chain within a supply chain risk management knowledge base, such as supply chain risk management knowledge base 220 in FIG. 2.

In this example, concepts 402 are transportation trips for shipping parts or products and include Reference Trip, Trip A, Trip B, and Trip C. Criteria 404 correspond to each transportation trip and include travel cost, total cost, novelty, locations, travel time, safety, accommodations, and travel quality. However, it should be noted that weighted decision matrix 400 may include any number and type of concepts 402 and criteria 404.

The supply chain risk manager generates weights 406 for criteria 404 using machine learning (e.g., using an artificial neural network). In other words, supply chain risk manager generates a weight for each criterion. In this example, travel cost and total cost have the highest weights and, therefore, present the highest risk to the supply chain.

The supply chain risk manager also generates a rating for each criterion using machine learning. In addition, the supply chain risk manager multiples the weight of each criterion with its corresponding rating to produce a score for each criterion. The supply chain risk manager then adds the scores for criteria 404 to generate total 408 for each concept in concepts 402.

The supply chain risk manager uses total 408 to produce rank 410 for each concept. In this example, Trip C has the highest total score, so the supply chain risk manager ranks Trip C one; Trip A has the second highest total score so the supply chain risk manager ranks Trip A two; and Trip B has the lowest total score, so the supply chain risk manager ranks Trip B three. In this example, decision 412 is whether to continue with a particular trip. Based on machine learning, total score, and rank, the supply chain risk manager decides to recommend that Trip C and Trip A continue, but that Trip B be discontinued.

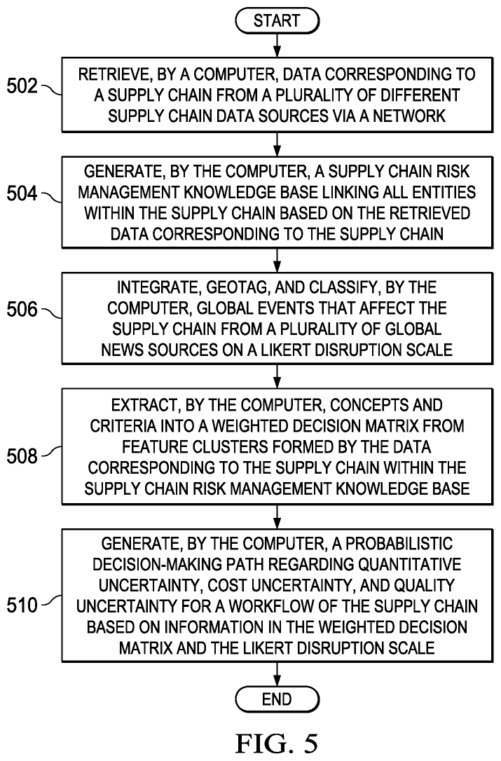

With reference now to FIG. 5, a flowchart illustrating a process for generating a probabilistic decision-making path is shown in accordance with an illustrative embodiment. The process shown in FIG. 5 may be implemented in a computer, such as, for example, server 104 in FIG. 1, data processing system 200 in FIG. 2, or computer 302 in FIG. 3.

The process begins when the computer retrieves data corresponding to a supply chain from a plurality of different supply chain data sources via a network (step 502). In addition, the computer generates a supply chain risk management knowledge base linking all entities within the supply chain based on the retrieved data corresponding to the supply chain (step 504). Further, the computer integrates, geotags, and classifies global events that affect the supply chain from a plurality of global news sources on a Likert disruption scale (step 506).

The computer also extracts concepts and criteria into a weighted decision matrix from feature clusters formed by the data corresponding to the supply chain within the supply chain risk management knowledge base (step 508). Furthermore, the computer generates a probabilistic decision-making path regarding quantitative uncertainty, cost uncertainty, and quality uncertainty for a workflow of the supply chain based on information in the weighted decision matrix and the Likert disruption scale (step 510). Thereafter, the process terminates.

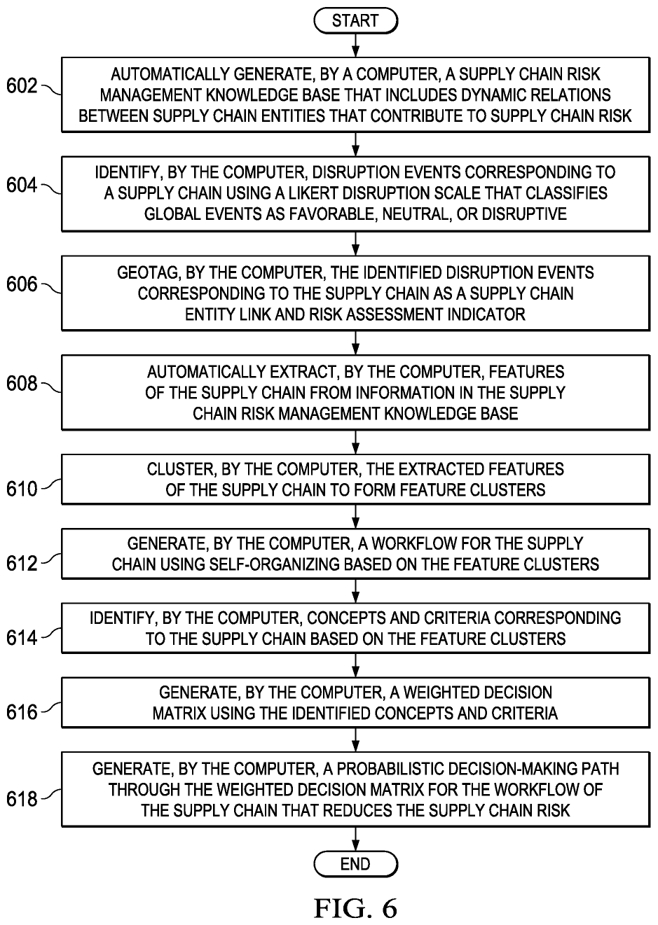

With reference now to FIG. 6, a flowchart illustrating a process for supply chain risk management is shown in accordance with an illustrative embodiment. The process shown in FIG. 6 may be implemented in a computer, such as, for example, server 104 in FIG. 1, data processing system 200 in FIG. 2, or computer 302 in FIG. 3.

The process begins when the computer automatically generates a supply chain risk management knowledge base that includes dynamic relations between supply chain entities that contribute to supply chain risk (step 602). In addition, the computer identifies disruption events corresponding to a supply chain using a Likert disruption scale that classifies global events as favorable, neutral, or disruptive (step 604). Further, the computer geotags the identified disruption events corresponding to the supply chain as a supply chain entity link and risk assessment indicator (step 606).

Furthermore, the computer automatically extracts features of the supply chain from information in the supply chain risk management knowledge base (step 608). The computer, using a clustering function, clusters the extracted features of the supply chain to form feature clusters (step 610). The computer generates a workflow for the supply chain using self-organizing based on the feature clusters (step 612).

The computer also identifies concepts and criteria corresponding to the supply chain based on the feature clusters (step 614). Moreover, the computer generates a weighted decision matrix using the identified concepts and criteria (step 616). Then, the computer, using machine learning, generates a probabilistic decision-making path through the weighted decision matrix for the workflow of the supply chain that reduces the supply chain risk (step 618). Thereafter, the process terminates.

Thus, illustrative embodiments of the present invention provide a computer-implemented method, computer system, and computer program product for generating and maintaining a supply chain risk management knowledge base with dynamic relations between supply chain entities that contribute to supply chain risk and for generating a probabilistic decision-making path through a weighted decision matrix corresponding to a supply chain using cognitive analysis to reduce the supply chain risk. As a result, illustrative embodiments generate supply chain insights that identify disruptions or problems in the supply chain before the disruptions impact business.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
automatically generating a supply chain risk management knowledge base that includes dynamic relations between supply chain entities that contribute to supply chain risk; and
generating a probabilistic decision-making path for a workflow of a supply chain that reduces the supply chain risk based on information extracted from the supply chain risk management knowledge base.

2. The computer-implemented method of claim 1 further comprising:
identifying disruption events corresponding to the supply chain using a Likert disruption scale that classifies global events; and
geotagging the disruption events corresponding to the supply chain as a supply chain entity link and risk assessment indicator.

3. The computer-implemented method of claim 1 further comprising:
automatically extracting features of the supply chain from information in the supply chain risk management knowledge base; and
clustering the features of the supply chain to form feature clusters.

4. The computer-implemented method of claim 3 further comprising:
generating the workflow for the supply chain using self-organizing based on the feature clusters.

5. The computer-implemented method of claim 3 further comprising:
identifying concepts and criteria corresponding to the supply chain based on the feature clusters; and
generating a weighted decision matrix using the concepts and criteria.

6. The computer-implemented method of claim 1 further comprising:
retrieving data corresponding to the supply chain from a plurality of different supply chain data sources via a network; and
generating the supply chain risk management knowledge base linking entities within the supply chain based on the data corresponding to the supply chain.

7. The computer-implemented method of claim 1 further comprising:
integrating, geotagging, and classifying global events that affect the supply chain from a plurality of global news sources on a Likert disruption scale.

8. The computer-implemented method of claim 1 further comprising:
generating the probabilistic decision-making path regarding quantitative uncertainty, cost uncertainty, and quality uncertainty for the workflow of the supply chain based on information in a weighted decision matrix and a Likert disruption scale corresponding to the supply chain.

9. The computer-implemented method of claim 1 further comprising:
estimating risk corresponding to the supply chain based on a probabilistic decision-making path through a weighted decision matrix and a classification of an event corresponding to the supply chain; and
responsive to determining that the risk corresponding to the supply chain is greater than a defined risk threshold level, performing one or more mitigation steps.

10. A computer system comprising:
a bus system;
a storage device connected to the bus system, wherein the storage device stores program instructions; and
a processor connected to the bus system, wherein the processor executes the program instructions to:
automatically generate a supply chain risk management knowledge base that includes dynamic relations between supply chain entities that contribute to supply chain risk; and
generate a probabilistic decision-making path for a workflow of a supply chain that reduces the supply chain risk based on information extracted from the supply chain risk management knowledge base.

11. The computer system of claim 10, wherein the processor further executes the program instructions to:
identify disruption events corresponding to the supply chain using a Likert disruption scale that classifies global events; and
geotag the disruption events corresponding to the supply chain as a supply chain entity link and risk assessment indicator.

12. The computer system of claim 10, wherein the processor further executes the program instructions to:
automatically extract features of the supply chain from information in the supply chain risk management knowledge base; and
cluster the features of the supply chain to form feature clusters.

13. The computer system of claim 12, wherein the processor further executes the program instructions to:
generate the workflow for the supply chain using self-organizing based on the feature clusters.

14. The computer system of claim 12, wherein the processor further executes the program instructions to:
identify concepts and criteria corresponding to the supply chain based on the feature clusters; and
generate a weighted decision matrix using the concepts and criteria.

15. A computer program product comprising a computer readable storage medium having program instructions embodied therewith, the program instructions executable by a computer to cause the computer to perform a method comprising:
automatically generating a supply chain risk management knowledge base that includes dynamic relations between supply chain entities that contribute to supply chain risk; and
generating a probabilistic decision-making path for a workflow of a supply chain that reduces the supply chain risk based on information extracted from the supply chain risk management knowledge base.

16. The computer program product of claim 15 further comprising:
identifying disruption events corresponding to the supply chain using a Likert disruption scale that classifies global events; and
geotagging the disruption events corresponding to the supply chain as a supply chain entity link and risk assessment indicator.

17. The computer program product of claim 15 further comprising:
automatically extracting features of the supply chain from information in the supply chain risk management knowledge base; and
clustering the features of the supply chain to form feature clusters.

18. The computer program product of claim 17 further comprising:
generating the workflow for the supply chain using self-organizing based on the feature clusters.

19. The computer program product of claim 17 further comprising:
identifying concepts and criteria corresponding to the supply chain based on the feature clusters; and
generating a weighted decision matrix using the concepts and criteria.

20. The computer program product of claim 15 further comprising:
retrieving data corresponding to the supply chain from a plurality of different supply chain data sources via a network; and
generating the supply chain risk management knowledge base linking entities within the supply chain based on the data corresponding to the supply chain.
